(19) United States
(12) Patent Application Publication
(10) Pub. No.: US 2013/0019465 A1
(43) Pub. Date: Jan. 24, 2013

(54) SELF-CONTAINED MAGNETIC TAPE DRIVE AND COMBINED MULTI-PART TAPE SYSTEM

(71) Applicants: EDWIN R. CHILDERS, TUCSON, AZ (US); KEVIN B. JUDD, TUCSON, AZ (US); JOSEPH C. RAMIREZ, TUCSON, AZ (US)

(72) Inventors: EDWIN R. CHILDERS, TUCSON, AZ (US); KEVIN B. JUDD, TUCSON, AZ (US); JOSEPH C. RAMIREZ, TUCSON, AZ (US)

(73) Assignee: INTERNATIONAL BUSINESS MACHINES CORPORATION, ARMONK, NY (US)

(21) Appl. No.: 13/457,236

(22) Filed: Apr. 26, 2012

Related U.S. Application Data
(63) Continuation of application No. 13/189,181, filed on Jul. 22, 2011.

(51) Int. Cl. G11B 5/84; G11B 5/78

(52) U.S. Cl. 29/603.01; 29/428

(57) ABSTRACT

Magnetic tape systems, magnetic tape and reel systems, magnetic tape drives and methods of manufacturing the systems and drives comprise, for the magnetic tape system, two lengths of magnetic tape of substantially equal width dimension; and a cleaning tape positioned between and joining the two lengths of magnetic tape, forming a combined multi-part tape having the cleaning tape contained between the two lengths of magnetic tape. In the tape drive, the tape, two reels, each reel supporting at least a distal end of the combined multi-part tape, and a magnetic tape head assembly are contained in a common enclosure, such that the magnetic tape drive is self-contained. Manufacturability is enhanced by having a very long combined multi-part tape made from two lengths of magnetic tape joined together by a cleaning tape.

### CROSS-REFERENCE TO RELATED APPLICATION

The present Application is a continuation of copending U.S. patent application Ser. No. 13/189,181, Filed Jul. 22, 2011.

### FIELD OF THE INVENTION

This invention relates to magnetic tape drives and magnetic tape arranged to store data.

### BACKGROUND OF THE INVENTION

Magnetic tape comprises an elongate data storage medium typically capable of storing large amounts of data at low cost. The data is typically arranged along the length of the tape, and, as such, the time required to access data is longer than that taken to access data from higher cost storage media, such as disk media, where the drive provides random access to the data on the rotating fixed disk. The magnetic tape is removable from a tape drive, usually in the form of tape cartridges having one or two tape reels and a length of magnetic tape wound on the reel(s), and keeps the cost of data storage low by amortizing the cost of the tape drive over a large number of tape cartridges. Tape is therefore typically thought of as a more archival data storage media, but often needs to be accessed. Tape libraries are employed to allow access to the data by storing tape cartridges on storage shelves while robots access the tape cartridges and deliver them to tape drives.

The time required to physically access a tape cartridge and to move it to a tape drive, and to mount the cartridge and thread the tape into the tape drive is considerable, and, if all the tape drives or robots are busy, the wait to find an available tape drive or robot can be a concern.

### SUMMARY OF THE INVENTION

Methods of manufacturing magnetic tape systems, magnetic tape and reel systems, magnetic tape drives that provide an entirely different perspective for storing data and for accessing data stored on magnetic tape.

In one embodiment, a magnetic tape drive comprises:

two lengths of magnetic tape of substantially equal width dimension;

a cleaning tape positioned between and joining the two lengths of magnetic tape, forming a combined multi-part tape having the cleaning tape contained between the two lengths of magnetic tape;

two reels, each reel supporting at least a distal end of the combined multi-part tape, and each reel having a tape carrying capacity substantially equal to the entirety of the combined multi-part tape;

a magnetic tape head assembly positioned to read and write with respect to the magnetic tape of the combined multi-part tape; and

a common enclosure containing the magnetic tape head assembly, the two reels, and the combined multi-part tape, such that the magnetic tape drive is self-contained.

Manufacturability is enhanced by having a very long combined multi-part tape made from two lengths of magnetic tape joined together by a cleaning tape.

In another embodiment, the common enclosure is arranged to seal the magnetic tape drive against external contaminants.

In a further embodiment, the cleaning tape is of substantially equal width dimension as the two lengths of magnetic tape.

In a still further embodiment, the cleaning tape is substantially 1% of length dimension of one of the two lengths of magnetic tape.

In another embodiment, the two lengths of magnetic tape additionally are of substantially equal length dimension, such that the cleaning tape is positioned at substantially the midpoint of the combined multi-part tape.

In still another embodiment, the two reels are fixedly mounted for rotation within the common enclosure.

In another embodiment, a magnetic tape system comprises two lengths of magnetic tape of substantially equal width dimension; and a cleaning tape positioned between and joining the two lengths of magnetic tape, forming a combined multi-part tape having the cleaning tape contained between the two lengths of magnetic tape.

In a further embodiment, a tape and reel system comprises the magnetic tape system and two reels, each reel supporting at least a distal end of the combined multi-part tape, and each reel having a tape carrying capacity substantially equal to the entirety of the combined multi-part tape.

Additional embodiments comprise methods for manufacturing a magnetic tape system comprising the steps of:

obtaining two lengths of magnetic tape of substantially equal width dimension;

obtaining a cleaning tape;

splicing one end of the cleaning tape and one end of one of the two lengths of magnetic tape; and

splicing the other end of the cleaning tape and one end of the other of the two lengths of magnetic tape, forming a combined multi-part tape having the cleaning tape contained between the two lengths of magnetic tape.

In another embodiment, a method for assembling a magnetic tape drive additionally comprises threading and winding the combined multi-part tape in a drive assembly, the drive assembly having two reels and a magnetic tape head assembly, the threading and winding such that each reel supports at least a distal end of the combined multi-part tape, and the magnetic tape head assembly is positioned to read and write with respect to the magnetic tape of the combined multi-part tape; and enclosing the multi-part tape and the drive assembly in a common enclosure such that the magnetic tape drive is self-contained.

For a fuller understanding of the present invention, reference should be made to the following detailed description taken in conjunction with the accompanying drawings.

### BRIEF DESCRIPTION OF THE DRAWINGS

FIG. 1 is a representation of constituents of a combined multi-part tape in accordance with an embodiment of the present invention, and is not to scale;

FIG. 2 is a representation of the combined multi-part tape derived from the constituents of FIG. 1, and is not to scale;

FIGS. 3 and 4 are views of a magnetic tape drive in accordance with an embodiment of the present invention, employing the combined multi-part tape of FIGS. 1 and 2; and

FIG. 5 is a flow chart depicting the manufacture of the combined multi-part tape of FIGS. 1 and 2; and the magnetic tape drive of FIGS. 3 and 4.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

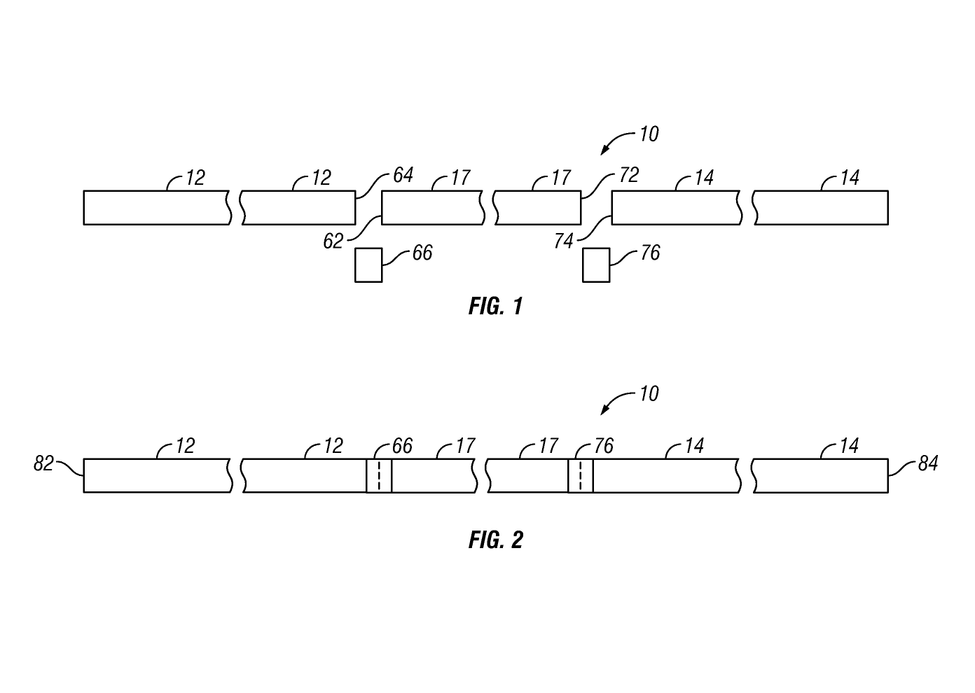

FIGS. 1 and 2 illustrate an example of an embodiment of a combined multi-part tape 10 in accordance with the present invention, in which a very long combined multi-part tape is provided to store large amounts of data. The tape is manufacturable by making it from two lengths of magnetic tape 12 and 14 joined together by a cleaning tape 17.

Typically, a magnetic tape is wound on a reel that is mounted in a removable cartridge, and the cartridge is stored on a shelf, for example in a tape library. Access to the data stored on the magnetic tape is provided by robots which access the tape cartridge from a storage shelf and delivers the cartridge to a tape drive. The time required to physically access a tape cartridge and to move it to a tape drive, and to mount the cartridge and thread the tape into the tape drive is considerable, and, if all the tape drives or robots are busy, the wait to find an available tape drive or robot can be a concern.

The combined multi-part tape 10 comprises sufficient data storage capacity in the two lengths of magnetic tape 12 and 14 to be the equivalent of many tape cartridges.

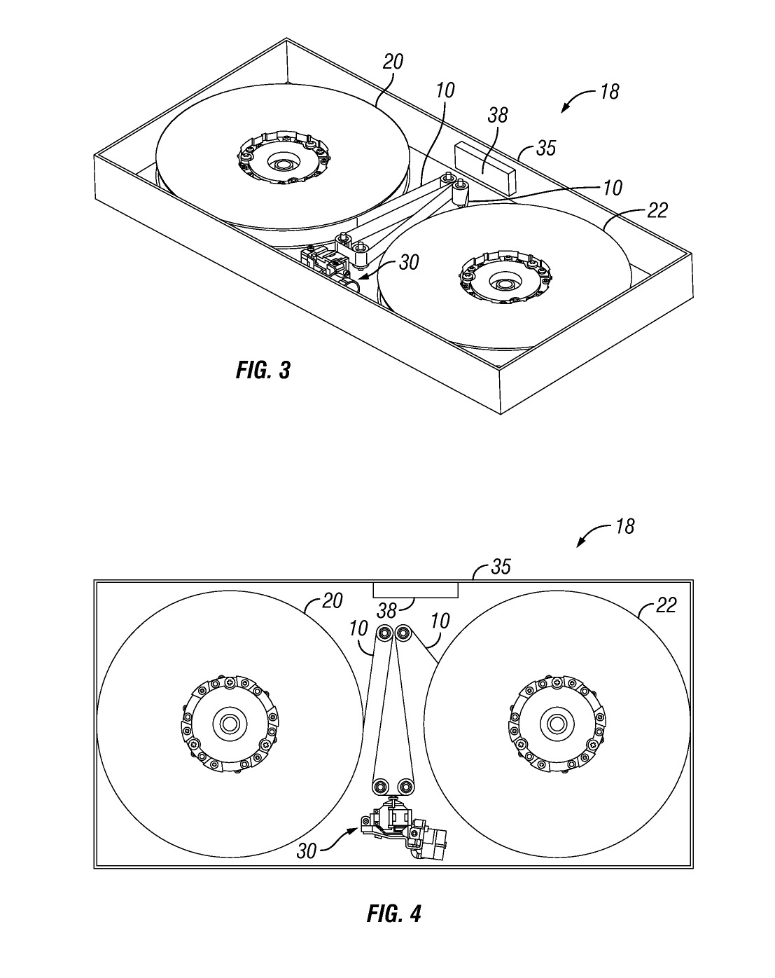

Referring to FIGS. 3 and 4, a magnetic tape drive 18 comprises the combined multi-part tape 10 which is mounted on two reels 20 and 22, and threaded past a magnetic tape head assembly 30, all in a common enclosure 35. The common enclosure 35 contains the magnetic tape head assembly, the two reels, and the combined multi-part tape, such that the magnetic tape drive 18 is self-contained.

The two reels 20 and 22 are fixedly mounted for rotation in the common enclosure 35, defined herein as reels that are not intended to be removed during normal use, but may be removed for repair or replacement if necessary. Thus, the combined multi-part tape is always available in the magnetic tape drive 18, and does not need to be loaded into a magnetic tape drive.

The reels 20 and 22 are rotatable by motors, such as pancake motors below the reels, so as to move the tape 10 with respect to the magnetic tape head assembly 30. The magnetic tape head assembly 30 comprises at least a magnetic tape head to read and to write data with respect to magnetic tape, and may also comprise a servo assembly to follow servo tracks written on the magnetic tape to align the magnetic tape head with data tracks offset from the servo tracks, as is well known to those of skill in the art. Examples of magnetic tape head assemblies comprise the IBM® LTO (Linear Tape Open) Generation 5 magnetic tape drive and the IBM® 3592E07 magnetic tape drive. The track following is performed by reading the servo tracks and comparing an actual position of the magnetic head to a desired position to provide a position error signal and to servo the magnetic head to reduce the error.

The common enclosure 35 containing the magnetic tape head assembly 30, the two reels 20 and 22, and the combined multi-part tape 10 is arranged to seal the magnetic tape drive 18 against external contaminants.

The magnetic tape drive 18 also comprises at least one controller 38 for operating the magnetic tape head assembly for reading and writing data, for operating the reel motors, for communicating externally of the magnetic tape drive, etc., as is known to those of skill in the art. The controller 38 may be internal or external of the common enclosure 35.

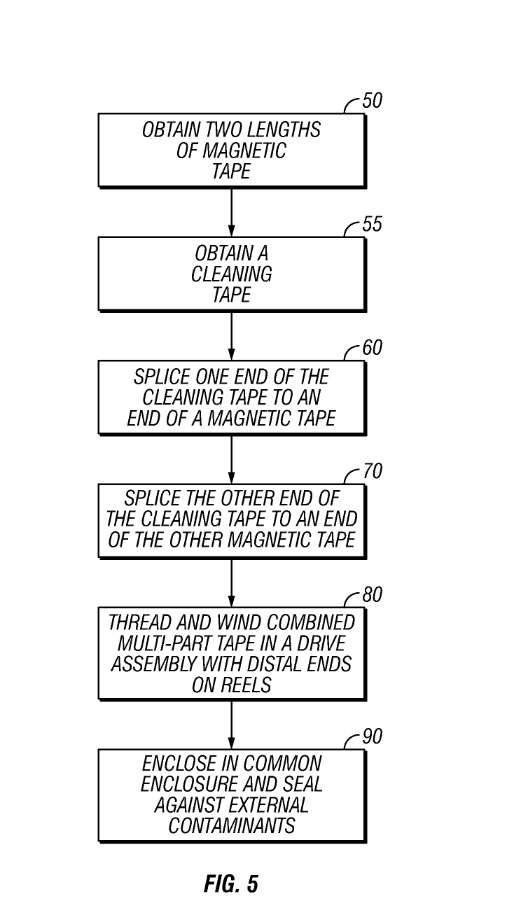

Referring to FIGS. 1, 2 and 5, an embodiment of a method to manufacture the combined multi-part tape 10 begins at step 50 and step 55, obtaining two lengths of magnetic tape 12 and 14 of substantially equal width dimension in step 50 and obtaining a cleaning tape 17 in step 55.

The lengths of magnetic tape 12 and 14 may be manufactured by any suitable means known to those of skill in the art. One example comprises slitting an elongated sheet of magnetic tape material into a plurality of individual lengths of tape of the desired width, and writing servo and format information onto the lengths of magnetic tape.

There are typically limits to the length of magnetic tape that may be reliably manufactured.

As one example, each of the obtained lengths of magnetic tape 12 and 14 are 2000 meters in length and ½ inch in width (12.65 mm). The two lengths of magnetic tape provide greater data storage capacity than a tape cartridge of a single, shorter length of magnetic tape.

The cleaning tape 17 obtained in step 55 comprises any suitable cleaning tape, and is the same width as the obtained lengths of magnetic tape 12 and 14, in the example ½ inch in width (12.65 mm). Many suitable types of cleaning tape are known and available in the art. One example comprises the cleaning tape discussed in U.S. Pat. No. 7,724,472, Biskeborn et al., May 10, 2010, assigned to International Business Machines Corporation.

As one example, the cleaning tape is substantially 1% of the length dimension of one of the two lengths of magnetic tape 12 and 14, in the example 1% is substantially 20 meters in length.

In step 60, one end of the cleaning tape 17 and one end of one of the two lengths of magnetic tape are spliced together, for example, end 62 of cleaning tape 17 is spliced to end 64 of length of magnetic tape 12. The splice is current technology, for example as is used in tape cartridges to splice a tape leader to the tape body, and comprises making matching patterns of the ends, placing the magnetic tape and cleaning tape together end to end to form a connection, and applying an adhesive material 66 over the connection. Splicing is also discussed in the Biskeborn et al. patent, above, and indicates that the matching ends may be straight across, slanted, or a “V” shape.

In step 70, the other end 72 of the cleaning tape 17 is spliced to one end 72 of the other of the two lengths of magnetic tape 14, with adhesive material 76 in the same manner as above.

The splices form a combined multi-part tape having the cleaning tape 17 contained between the two lengths of magnetic tape 12 and 14.

Cleaning tape 17 both provides the attachment between the two lengths of magnetic tape 12 and 14, making the combined tape 10 longer than is possible with only one of the lengths of magnetic tape, and also provides a means of cleaning tape debris from the magnetic tape head of assembly 30 of FIGS. 3 and 4. The enclosure 35 may be arranged to protect the tape drive 18 from external contaminants such as dust, but tape debris is generated internally as the tape drive 18 is used and tends to accumulate at the magnetic tape head.

Referring to FIG. 2, there is no requirement that the two lengths of magnetic tape 12 and 14 be the same length and they may be of unequal lengths. If they are substantially the same length, the cleaning tape 17 is placed at substantially the midpoint of the combined multi-part tape 10, and if the two lengths of magnetic tape are different, the cleaning tape 17 is offset from the midpoint of the multi-part tape 10. However, if the two lengths of magnetic tape 12 and 14 are slit from the same sheet or similar sheets, they are of the same length, and using them both at their full length effectively doubles the useful amount of magnetic tape for storage of data.

Referring to FIGS. 2, 3, 4 and 5, step 80 comprises threading and winding the combined multi-part tape 10 in the drive assembly 18. In one embodiment, the two reels 20 and 22 are fixedly mounted for rotation within the common enclosure 35. The reels are rotatable by motors, such as pancake motors below the reels. In one embodiment, the combined multi-part tape 10 is wound onto one of the two reels 20 and 22, threaded through the magnetic tape head assembly 30 and wound onto the other of the tape reels. In one example, distal end 82 is placed at the hub of reel 20 and wound onto the reel, as is known in the art. In one example, a small amount of liquid or adhesive is placed on the hub to provide stiction, the distal end 82 placed at the hub and the reel 20 is rotated in the direction to wind the multi-part tape 10 onto the reel 20. After a few revolutions, the distal end of the tape is positioned on the hub under a sufficient number of wraps such that it will not slip. In the example, the combined multi-part tape is wound almost entirely on reel 20. Then, the other distal end 84 of the combined multi-part tape 10 is threaded through the magnetic tape head assembly 30 and to the other reel 22. The distal end 84 is placed at the hub of reel 22 and wound onto the reel, as is known in the art. As above, in one example, a small amount of liquid or adhesive is placed on the hub to provide stiction, the distal end 84 placed at the hub and the reel 22 is rotated in the direction to wind the multi-part tape 10 onto the reel 22. Reel 20 may be rotated in the direction to supply or feed the combined multi-part tape towards the magnetic tape head assembly 30 and towards the reel 22. After a few revolutions of reel 22, the distal end 84 of the tape is positioned on the hub under a sufficient number of wraps such that it will not slip.

Thus, the threading and winding of step 80 is such that each reel 20 and 22 supports at least a distal end 82 and 84 of the combined multi-part tape 10, and the magnetic tape head assembly 30 is positioned to read and write with respect to the magnetic tape of said combined multi-part tape 10.

In step 90, the remainder of common enclosure 35 is placed to enclose the multi-part tape 10 and the drive assembly such that the magnetic tape drive 18 is self-contained. The controller 38 and suitable connections to operate the tape drive and transfer data may be supplied at any point prior to enclosure of the tape drive. In one embodiment, the common enclosure is arranged to seal the magnetic tape drive against external contaminants. In so doing, the common enclosure is not totally sealed, but rather has openings with suitable filters to prevent external contaminants, such as dust particles, from entering the magnetic tape drive 18, as is known in the art.

When it is desired to clean the magnetic tape head of magnetic tape head assembly 30, the controller 38 rotates the reels 20 and 22 to move the cleaning tape 17 to and across the magnetic tape head, and may move the cleaning tape back and forth in a rubbing action across the magnetic tape head.

A person of ordinary skill in the art will appreciate that the embodiments of the controller 38 may take the form of an entirely hardware embodiment, an entirely software embodiment (including firmware, resident software, micro-code, etc.) or a combination thereof, such as an embodiment combining software and hardware aspects that may all generally be referred to herein as a “circuit,” “module” or “system.”

The self-contained magnetic tape drive 18 provides a large amount of tape that is available to be read or written without the necessity of accessing a tape cartridge, moving the tape cartridge to a tape drive, and loading the tape into the tape drive. The large amount of tape is made possible by having a combined multi-part tape of two lengths of magnetic tape 12 and 14 connected by cleaning tape 17 which both provides the attachment between the two lengths of magnetic tape 12 and 14, making the combined tape 10 longer than is possible with only one of the lengths of magnetic tape, and also provides a means of cleaning tape debris from the magnetic tape head of assembly 30.

Embodiments of the present invention are described above with reference to flowchart illustrations according to embodiments of the invention. It will be understood that each block of the flowchart illustrations, and combinations of blocks in the flowchart illustrations, can be implemented by computer program instructions which operate apparatus to conduct the functions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

1-7. (canceled)

8. A method for manufacturing a magnetic tape system comprising the steps of:
obtaining two lengths of data storage magnetic tape of substantially equal length, and of substantially equal width dimension;
obtaining a joining tape having a length of substantially 1% of the length dimension of either of said two lengths of data storage magnetic tape, and of substantially equal width dimension as said two lengths of magnetic tape, said joining tape comprising a cleaning tape;
splicing one end of said joining and cleaning tape and one end of one of said two lengths of data storage magnetic tape; and
splicing the other end of said joining and cleaning tape and one end of the other of said two lengths of magnetic tape, forming a combined multi-part data storage tape having substantially twice the data storage capacity as either single length of magnetic tape.

9. A method for assembling a magnetic tape drive comprising the steps of:
obtaining two lengths of data storage magnetic tape of substantially equal length, and of substantially equal width dimension;
obtaining a joining tape having a length of substantially 1% of the length dimension of either of said two lengths of data storage magnetic tape, and of substantially equal width dimension as said two lengths of magnetic tape, said joining tape comprising a cleaning tape;
splicing one end of said joining and cleaning tape and one end of one of said two lengths of data storage magnetic tape;
splicing the other end of said joining and cleaning tape and one end of the other of said two lengths of magnetic tape, forming a combined multi-part data storage tape having substantially twice the data storage capacity as either single length of magnetic tape;
threading and winding said combined multi-part data storage tape in a drive assembly, said drive assembly having two reels and a magnetic tape head assembly, said threading and winding such that each reel supports at least a distal end of said combined multi-part tape, and said magnetic tape head assembly is positioned to read and write with respect to said magnetic tape of said combined multi-part tape; and
enclosing said multi-part tape and said drive assembly in a common enclosure such that said magnetic tape drive is self-contained.
